(19) United States
(12) Patent Application Publication
(10) Pub. No.: US 2012/0089461 A1
(43) Pub. Date: Apr. 12, 2012

(54) METHOD FOR IMPROVED ADVERTISING ON A MOBILE DEVICE

(76) Inventor: Aaron J. Greenspan, Palo Alto, CA (US)

(21) Appl. No.: 12/900,428

(22) Filed: Oct. 7, 2010

(51) Int. Cl. G06Q 30/00; G06Q 20/00

(52) U.S. Cl. 705/14.58; 705/44

(57) ABSTRACT

A first embodiment includes a method for providing targeted promotional offers from an advertiser to an advertisee that includes receiving location information of a mobile device belonging to the advertisee, searching through a promotional offer database, selecting a promotional offer using the location information of the mobile device as a selection criterion, sending the promotional offer to the mobile device, receiving a redemption notification indicating that an advertisee has applied the promotional offer to a completed purchase transaction, and charging the advertiser a promotional offer fee after receiving the redemption notification. In a second embodiment, an advertising system is integrated with a payment system, such as the one disclosed in related U.S. patent application Ser. No. 12/641,071, using credit cards, debit cards, gift credit, social credit, or any suitable payment method.

### CROSS-REFERENCE TO RELATED APPLICATIONS

This application is related to U.S. patent application Ser. No. 12/641,071, filed on 17 Dec. 2009, which is incorporated in its entirety by this reference.

### TECHNICAL FIELD

This invention relates generally to the advertising field, and more specifically to a useful and improved method for advertising on a mobile device.

### BACKGROUND

Advertising plays an important role in American commerce. The benefits of advertising include among other things, brand development, consumer outreach and increased sales. In traditional advertising, however, the cost of advertising is typically measured in an aggregate or per-impression basis, and is typically independent of the actual effectiveness of the advertising campaign. Since the revenue generated by an advertising campaign is unknown prior to the campaign launch, advertisers undertake a risk that the benefit of advertising often fails to offset. As a response to advertising risk, many advertisers attempt to increase advertising effectiveness by flooding the market with advertisements in an attempt to reach a greater audience. However, such flooding can lead to consumer annoyance and decreased consumer sensitivity. Thus, there is a need in the advertising field for a useful and improved method for advertising. This invention provides such useful and improved method for advertising on a mobile device.

### BRIEF DESCRIPTION OF THE FIGURES

FIG. 1 is a schematic representation of a method of a first preferred embodiment for advertising on a mobile device;

FIG. 2 is an exemplary representation of a promotional offer on a mobile device;

FIG. 3 is a schematic representation of using selection criteria for advertising on a mobile device;

FIG. 4 is a schematic representation of automatically applying a flagged promotional offer;

FIG. 5 is a schematic representation of sharing a promotional offer;

FIG. 6 is a schematic representation of predicting location for selection of promotional offers; and

FIGS. 7 and 8 are schematic representations of a method of a second preferred embodiment for advertising on a mobile device.

### DESCRIPTION OF THE PREFERRED EMBODIMENTS

The following description of the preferred embodiments of the invention is not intended to limit the invention to these preferred embodiments, but rather to enable any person skilled in the art to make and use this invention.

### 1. Method of the First Preferred Embodiment

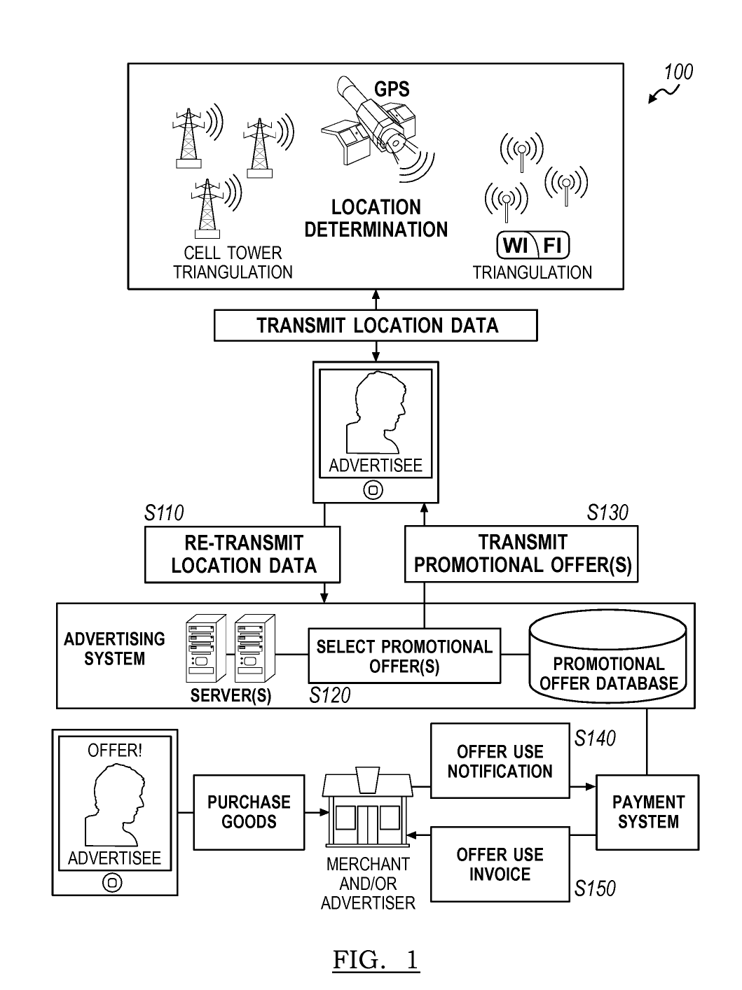

As shown in FIG. 1, a method 100 of a first preferred embodiment for advertising on a mobile device 100 provides targeted advertising to an advertisee by: receiving the location of a mobile device belonging to the advertisee S110, selecting a promotional offer S120, using the location of the mobile device as a selection criterion, sending the selected promotional offer to the mobile device S130, receiving a redemption notification that the promotional offer has been applied to a completed purchase transaction S140, and charging the advertiser a fee after receiving the redemption notice S150. Within this document, the term “advertisee” refers to the recipient of an advertisement (from an advertiser).

The method of the first preferred embodiment is preferably implemented by and over an electronic network. The network preferably includes a plurality of mobile devices (each mobile device belonging to an advertisee), a user account database, a promotional offer database, a user review database, and one or more advertising servers. The advertising system preferably comprises the promotional offer database and the one or more advertising servers. The advertising server preferably receives location information from the plurality of mobile devices, selects promotional offers from the promotional offer database, and distributes the promotional offers over the network to the mobile devices. Preferably, the network is connected to the payment systems of the advertisers, such that redemption notifications may be automatically sent to the advertising server when a promotional offer is redeemed. The method may, however, be implemented by any suitable device or system.

In an exemplary application of the method, an advertising system receives the location of a mobile device belonging to an advertisee who is on his way to work. The advertising system searches a database for any promotional offer offered by a merchant whose store is located near the current location of the advertisee. The advertising system then sends the promotional offer(s) to a software application running on the mobile computing device (e.g., a smart phone) of the advertisee. The application is preferably a native application but may alternatively be a web-based application utilizing positioning capabilities of the mobile computing device. The advertisee views the promotional offer and stops by the store of the merchant. Before making the purchase, the advertisee reserves an instance of the promotional offer by tapping a “Redeem” button or any suitable initiator on the smart phone application. Preferably, this sets in motion a timing mechanism that allows for a set period of time for the advertisee to take advantage of the offer. For example, a promotional offer may only be redeemable for one hour after being requested, after which it is no longer reserved for the advetisee and may be used by someone else This may be used to allow an advertiser to set a maximum number of redemptions of a given promotional offer, and also to avoid hoarding of promotional offers for long periods of time. The merchant handles payment for the transaction as usual and in the process of requesting payment from the advertisee, the promotion is automatically applied. Once payment is complete, the advertising system charges the merchant a corresponding promotional offer fee (i.e. an advertising fee).

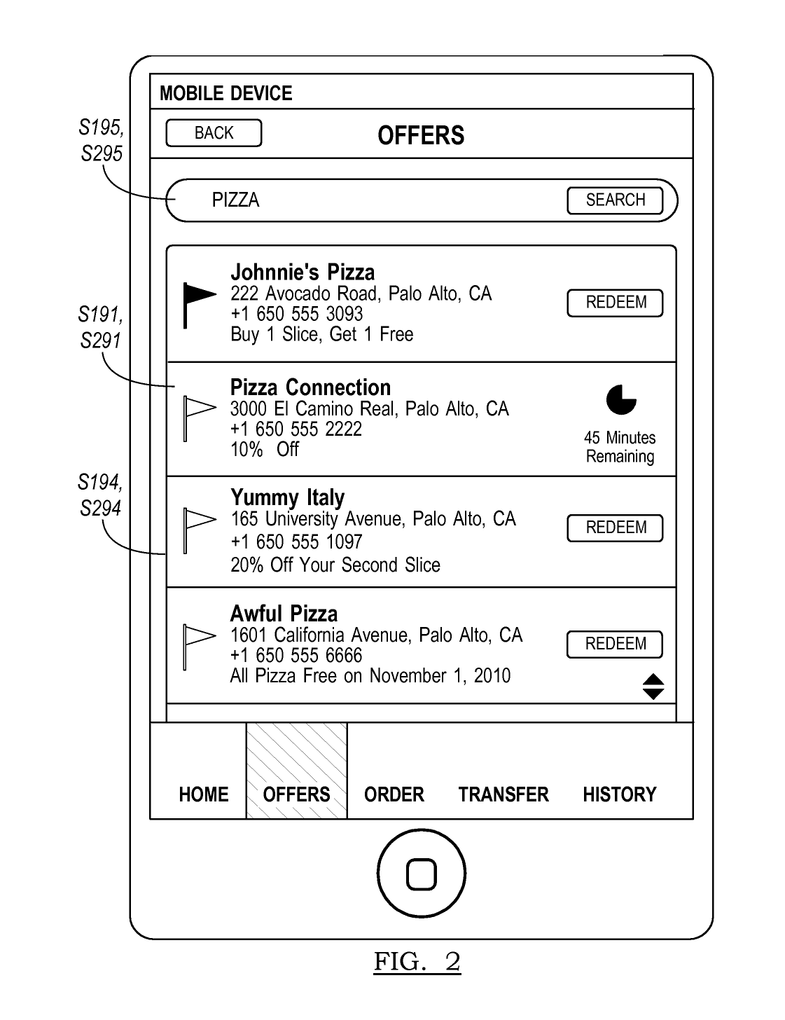

As shown in FIG. 2-6, the method of the first preferred embodiment 100 may additionally include one or more of the following optional steps: saving a promotional offer flagged by the advertisee as an offer of interest S191, performing a promotional offer share request from the advertisee S192, sorting a list of selected promotional offers S193, receiving a user review submission from the advertisee S194, providing a search interface to the promotional offer database S195, and calculating a velocity of the mobile device S196.

Step S110, which includes receiving information about the location of a mobile device belonging to an advertisee, functions to determine the location of the advertisee. The mobile device may be a smart phone, a portable computer, a personal global positioning System (GPS) device, or any other suitable device with location tracking capabilities. The location information is preferably obtained by GPS, but may alternatively be obtained through Internet location techniques, telephone tower triangulation, or any suitable location determination technique. Preferably, the location information is in the form of latitude and longitude (GPS) coordinates, but may alternatively be street addresses or any other suitable location format. The location information may include a time stamp. The location information is preferably the real time location of the mobile device. Preferably, an advertising system receives automatic location updates from the mobile device. Alternatively, the advertising system may poll the mobile device for the location information. The advertising system may poll the mobile device at set time intervals or at specific times. For example, the advertising system may poll the mobile device at lunchtime, in order to find promotional (lunch) offers from nearby restaurants.

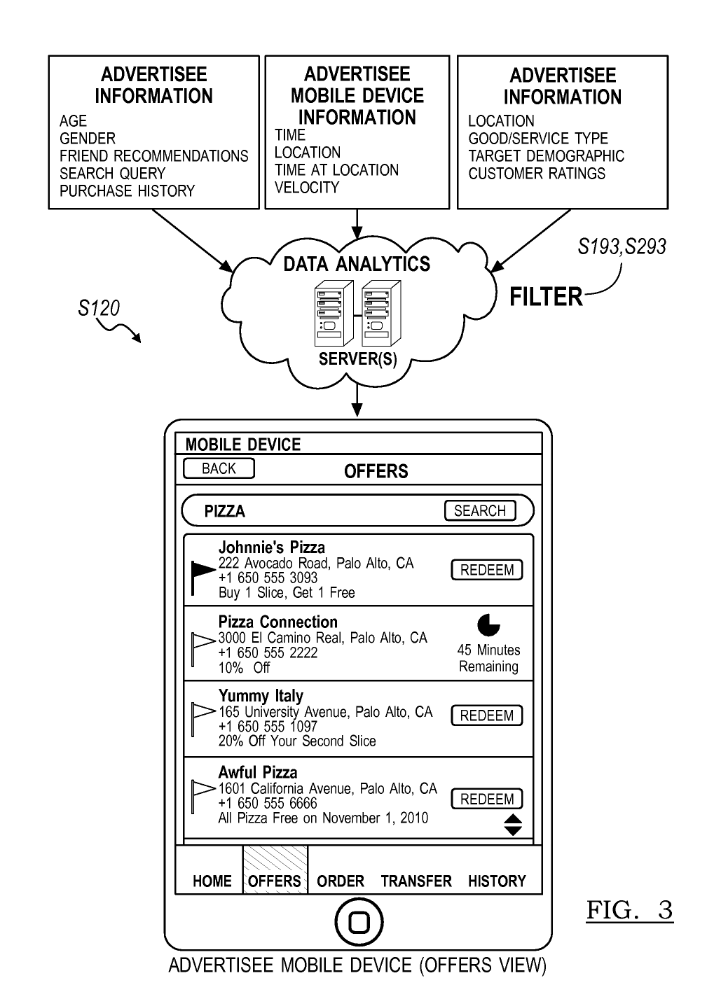

As shown in FIG. 3, Step S120, which includes selecting promotional offers to send to the mobile device of the advertisee, functions to provide a targeted advertising experience to the advertisee. Step S120 may select a single promotional offer or alternatively may select a set of promotional offers. Promotional offers are preferably created by advertisers. An advertiser is preferably the person or entity whose products or services are the subject matter of the promotional offer, such as a merchant, but may alternatively be an authorized representative, such as an advertising agency. Promotional offers are preferably selected from a promotional offer database, but may alternatively be selected from a plurality of databases. The promotional offer database is preferably an internal database of the advertising system, but may alternatively be any database containing promotional offers, including third party databases on the Internet. The promotional offer database may be searchable by location (e.g. location of the mobile device) and may implement result fillers. For example, the system may search for promotional offers redeemable within a 0.5 mile radius of the input location; promotional offers redeemable outside a 0.5 mile radius are filtered out of the search results. Optionally, the promotional offer database returns sorted search results. For example, search results may be sorted by the distance between the input location and the promotional offer redemption location. Additionally, Step S120 preferably uses selection criteria to create a more targeted ad experience for the advertisee, and more specifically S120 preferably uses the location of the mobile device as a selection criterion.

The advertising system may analyze the time-stamped location information to determine special locations. For example, advertisees may be more likely to take advantage of promotional offers near their home or work place, and those locations can be given special status. Thus, if the location of the mobile device is static for a prolonged period during work hours, the system may deduce that the location is the place of work of the advertisee and give that location special status. The advertising system may analyze the location information to determine travel routes of the advertisee. For example, advertisees may be more likely to take advantage of promotional offers redeemable at locations “on the way.” Thus, the system may select promotional offer redeemable at locations on common travel routes of the advertisee. In addition using location as a selection criterion, S120 may optionally use additional selection criteria, which are described in further detail in section “1.1 Selection Criteria for Selecting a Promotional Offer” below.

When a plurality of promotional offers has been selected during Step S120, the offers are preferably organized in a list. The list is preferably a sorted list, but may alternatively be an unsorted list. The list preferably includes both promotional offers selected by the advertising system as well as any promotional offers shared by other users. Alternatively, separate lists may be used to store system-selected promotional offers and shared promotional offers. Promotional offer sharing is further described in Step S192 below.

Step S130, which includes sending the selected promotional offers to the mobile device, functions to present the promotional offers to the advertisee. The data is preferably sent to an application running on the mobile device through an internet communication protocol, but may alternatively be sent via e-mail or text messaging (SMS). The application may communicate with the advertising system through an application programming interface (API). Upon sending the selected promotional offer, the promotional offer(s) are preferably presented to the advertisee through any suitable interface of an application.

Step S140, which includes receiving a redemption notification that an advertisee has applied the promotional offer to a completed purchase transaction, functions to notify the advertising system that it can charge the advertiser for a successful conversion. Preferably, but not necessarily, the advertisee applies the promotional offer by showing the promotional offer, displayed on the mobile device, to the merchant (who may also be the advertiser). Paying for goods or services through an associated payment system may automatically apply the promotional offer. The advertisee may alternatively communicate an intent to use the promotional offer in any suitable manner such as the mobile device sending an electronic message or displaying a graphical code before or during the payment transaction. There may also be a limit to the number of promotional offers an advertisee may use in a set amount of time or based on any suitable rule. For example, an advertisee may only be limited to using a set number of promotional offers in one hour or similarly may be limited to using promotional offers in a set geographical area for an amount of time. In an appropriate situation, such a rule will preferably deactivate a promotional offer or prevent a promotional offer from being applied. The redemption notification is preferably sent from the advertiser, and is preferably transmitted automatically over a network connection. The advertiser may send a redemption notification each time a promotional offer is redeemed, or may alternatively send a redemption notification with the total number of promotional offers redeemed during a specified time period. For example, the advertiser may send a redemption notification every hour, wherein the redemption notification contains the total number of times each promotional offer has been redeemed during the previous hour. Alternatively, the redemption notification may be sent by the mobile device of the advertisee, preferably after the purchase is complete.

Step S150, which includes charging the advertiser a promotional offer fee after receiving a redemption notification, functions to generate revenue for the advertising system. Since the advertiser is preferably charged only for redeemed promotional offers (i.e. after a sale has been made), the financial risk associated with advertising a promotional offer is greatly reduced. Preferably, the advertising system charges the advertiser upon receiving each redemption notification, wherein the promotional offer fee is calculated from the individual redemption notification. Alternatively, the advertising system may charge the advertiser once per specified time period, wherein the promotional offer fee is calculated from all redemption notifications received during the previous time period.

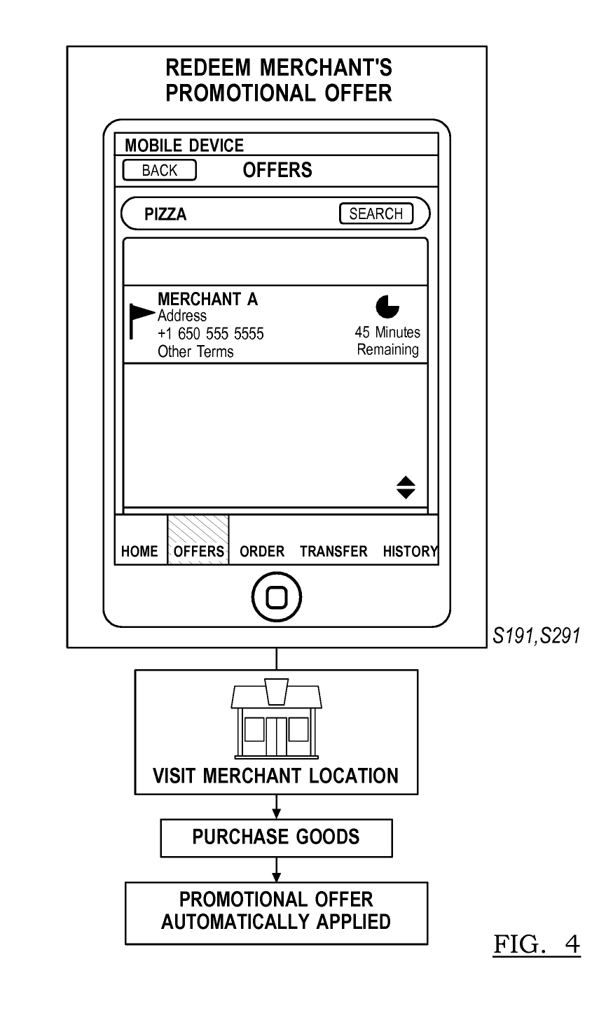

Optional Step S191, which includes allowing the advertisee to flag the promotional offer as an offer of interest and saving the flagged promotional offer on the mobile device, functions to help advertisees manage the promotional offers sent by the advertising system. Step S191 may additionally save the flagged promotional offer on a server and preferably in an account of the advertisee in a user accounts database of the advertising system. Step S191 may include deleting the flagged promotional offer from the mobile device after the expiration of a specified time interval. For example, a flagged promotional offer may be deleted from the mobile device if the advertisee does not redeem the promotional offer within a week. As shown in FIG. 4, a flagged promotional offer (or alternatively a previously selected promotional offer) may additionally be automatically redeemed. When the advertisee is located at the location of the advertiser of which a promotional offer has been selected or flagged, the promotional offer is preferably automatically applied. Alternatively, the promotional offer may automatically be applied based on a transaction with the advertiser or based on any suitable criteria.

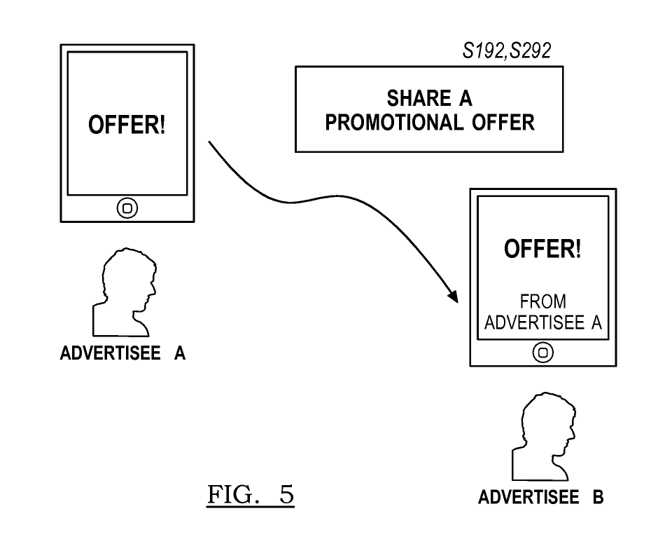

Optional Step S192, which includes receiving a request from the advertisee to share a promotional offer with a second advertisee and sending the promotional offer to the mobile device of the second advertisee, functions to allow for user-driven advertising distribution as shown in FIG. 5. The second advertisee is preferably a personal acquaintance of the advertisee, but can alternatively be any person capable of receiving promotional offers from the advertising system. The advertisee may, but need not, flag the promotional offer as an offer if interest before sharing. For example, an advertisee may personally be uninterested in a promotional offer for a plasma TV and thus not flag the promotional offer, but may share it with a friend who the advertisee thinks might be interested. A shared promotional offer refers to a promotional offer that is sent to a mobile device of a second advertisee as the result of a share request of a first advertisee.

Optional S193, which includes sorting the list according to sorting criteria, functions to ensure that the advertisee sees high-preference promotional offers before seeing low-preference promotional offers. This step may be useful when a plurality of promotional offers are selected in Step S120, and the offers are preferably organized in a list. The sorting criteria may include any selection criteria described in section “1.1 Selection Criteria for Selecting a Promotional Offer” below, but may alternatively be any suitable sorting criteria. When the list contains shared promotional offers, the identity information of the sharer may be used as a sorting criterion. For example, if sharer is a close friend or a shopping buddy, the shared promotional offer may feature high on the list. Alternatively, if the sharer sends a high volume of share requests, then the sharer may be identified as a spammer and the promotional offer may feature low on the list, or may alternatively be removed from the list.

Optional Step S194, which includes receiving a user review submission from the advertisee about an advertiser or a promotional offer, functions to provide feedback to the advertising system. The user review submission is preferably received from the mobile device of the advertisee, and more preferably from an application running on the mobile device. Alternatively, the user review submission may be received through any web browser over the Internet. Step 194 preferably includes saving the submission in a user review database of the advertising system. A promotional offer may be selected at least partially based on received user reviews of an advertiser or promotional offer. The promotional offers may additionally be used as sorting criteria of a plurality of selected promotional offers.

Optional Step S195, which includes providing a search interface to a promotional offer database, functions to allow a user to search for promotional offers residing in the promotional offer database. Preferably, the search interface is accessible through an application running on the mobile device. Alternatively, the search interface may be accessible through any web browser over the Internet. The search interface preferably allows the advertisee to search by geographic area, advertiser, product type, promotional offer type, or any other suitable search criteria. A promotional offer may be selected from the search interface for use with an advertiser.

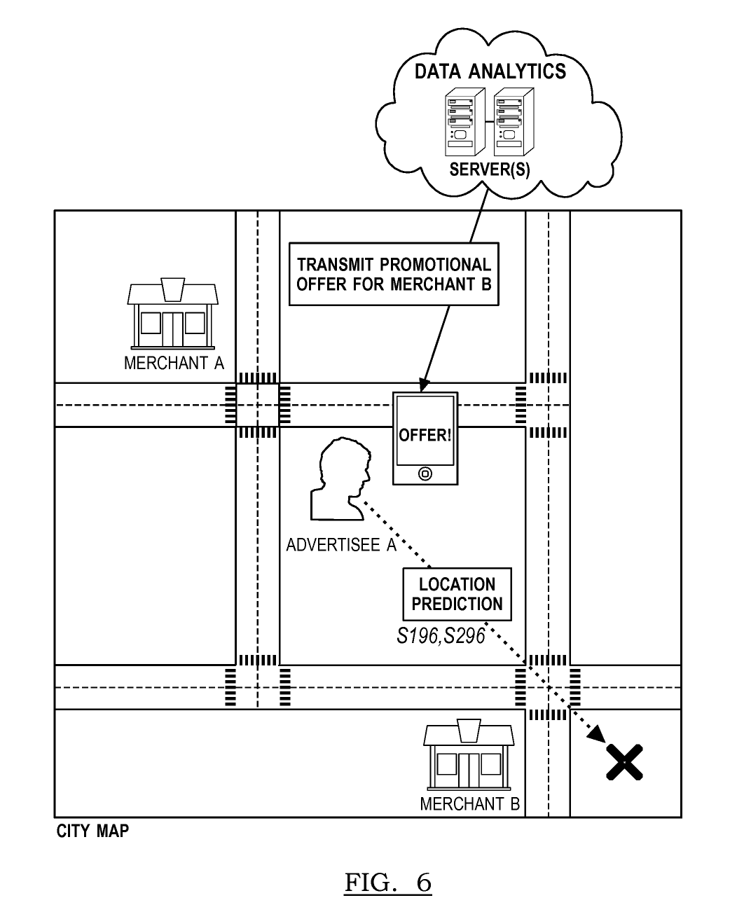

Optional Step S196, which includes calculating the velocity of the mobile device using the location information received in Step S110, functions to use location prediction during the selection of promotional offers as shown in FIG. 6. The calculated velocity may be used to determine whether the advertisee is stationary, traveling by foot, or traveling by car. The calculated velocity may be used as a selection criterion in Step S120. For example, if an advertisee is traveling at the velocity of 50 mph heading west, a selection criterion may include searching for promotional offers redeemable within a 20 mile radius (approximately 25 minutes away). In addition, the search results may be further filtered such that only promotional offers redeemable at locations in the direction of travel are selected. Thus, a promotional offer redeemable at a location east, substantially north, or substantially south of the advertisee would preferably be filtered out. As another example, if the calculated velocity is 3 mph heading west, the system may deduce that the advertisee is traveling by foot. Thus, the advertising system may select a promotional offer whose redemption location has a street front on the street on which the advertisee is traveling.

### 1.1 Selection Criteria for Selecting a Promotional Offer

Optionally, Step 120 uses additional selection criteria based on personal information of the advertisee and population level information. Personal information of the advertisee may include past purchase history, promotional offer redemption history, personal interests and preferences, demographic information, or any additional suitable personal information. In the preferred embodiment, personal information is obtained from an accounts database that is an internal database of the advertising system. In an alternate embodiment, personal information may be obtained from any database or databases, containing personal information of the advertisee, including third party databases on the Internet.

Population level information includes user reviews of the advertiser, user reviews of the promotional offer, redemption statistics of the promotional offer or similar promotional offers, or any additional suitable population level information.

The system may use user reviews to offer a better user experience to the advertisee. For example, if an advertiser consistently receives high reviews for its services or products, the advertising system may be more likely to select promotional offers from that advertiser. As another example, if a promotional offer receives high reviews, the advertising system may be more likely to select that promotional offer. User reviews may be weighted based on content of the review. For example, a review may receive greater weight when other users vote it as a helpful or candid review, and a review may receive little or no weight if voted as an unhelpful or biased review. User reviews may be weighted based on the identity of the reviewer or the length (in words) of the review. For example, a review may receive greater weight when the reviewer shares a high degree of similarity with the advertisee or when the reviewer consistently submits helpful or candid reviews.

User review information is preferably obtained from a user review database. The user review database is preferably an internal database of the advertising system and preferably contains user review submissions from the advertisees. The user review database may additionally or alternatively contain user review information scraped from third party user review repositories, including user review websites on the Internet. Preferably, the user review database is searchable by both advertiser and by promotional offer. Alternatively, user review information may be obtained directly from any database or databases containing user review information, including third-party databases on the Internet.

Redemption statistics of a promotional offer or similar promotional offers may be used to project the total number of redemptions for a promotional offer. Redemption statistics may be for past promotional periods or the current promotional period. For example, if the promotional offer is a recurring promotional offer (e.g. offered once every year), redemption statistics of past years are a reliable indicator for the popularity of the promotional offer in the current year. Thus, the system may be more likely to select a promotional offer that has been popular in past years than one that has had limited success in past years. As another example, the system may select a promotional offer that has been frequently redeemed in the current promotional period over a less frequently redeemed promotional offer.

Examples of similar promotional offers include promotional offers for similar products from the same advertiser, promotional offers for similar products by a different advertiser, and promotional offers for different products from the same advertiser. Additional examples of similar promotional offers include promotional offers of a similar offer type (e.g. get a free x with any purchase of y, promotional trial, buy one get one free, etc.) and promotional offers with a similar discount rate (e.g. 40%-50% off).

Selection criteria may also include promotional offer introduction date, promotional offer expiration date, or the current time. The introduction and expiration date of the promotional offer may be used with known trends of consumer behavior to increase advertising effectiveness. For example, if consumer behavioral trends indicate that promotional offers are most frequently redeemed the last weekend that the offers are available, the promotional offer expiration date can be used to select promotional offers that expire after the upcoming weekend. Finally, current time may include both date and time information. For example, the date may be used as a selection criterion when the promotional offer features ice cream, such that the promotional offer is more likely to be selected during summer months than winter months. As another example, time of day may be used as a selection criterion when the promotional offer features coffee, such that the promotional offer is more likely to be selected during morning hours than late at night. In another embodiment, date and time information may be used as a selection criterion, such that a promotional offer is not selected when the advertiser (i.e. store or office) is closed.

Selection criteria may additionally prevent promotional offer conflicts. This preferably prevents users from using multiple promotional offers at a time such as when only one valid promotional offer is usable at any one time. The system may not allow an advertisee to accumulate conflicting promotional offers, but may alternatively limit how many can be used during any suitable time period. This may be applied during the automatic application of the promotional offer. The selection criteria may alternatively select the best promotional offer for the advertisee or use any suitable criteria.

In addition to providing a more targeted advertising experience, selection criteria may also be used to maximize advertising revenue. Selection criteria may include the promotional offer fee. The system charges the advertiser a promotional offer fee each time an advertisee redeems a promotional offer (i.e. applies a promotional offer to a purchase transaction). The promotional offer fee may be used with a projected total number of redemptions to maximize advertising profit. For example, if promotional offer A has a $1 promotional offer fee and a projected redemption total of 50, and promotional offer B has a $2 promotional offer fee and a projected redemption total of 30, the system may select promotional offer B over promotional offer A ($1.50<$2.30.

### 2. Method of the Second Preferred Embodiment

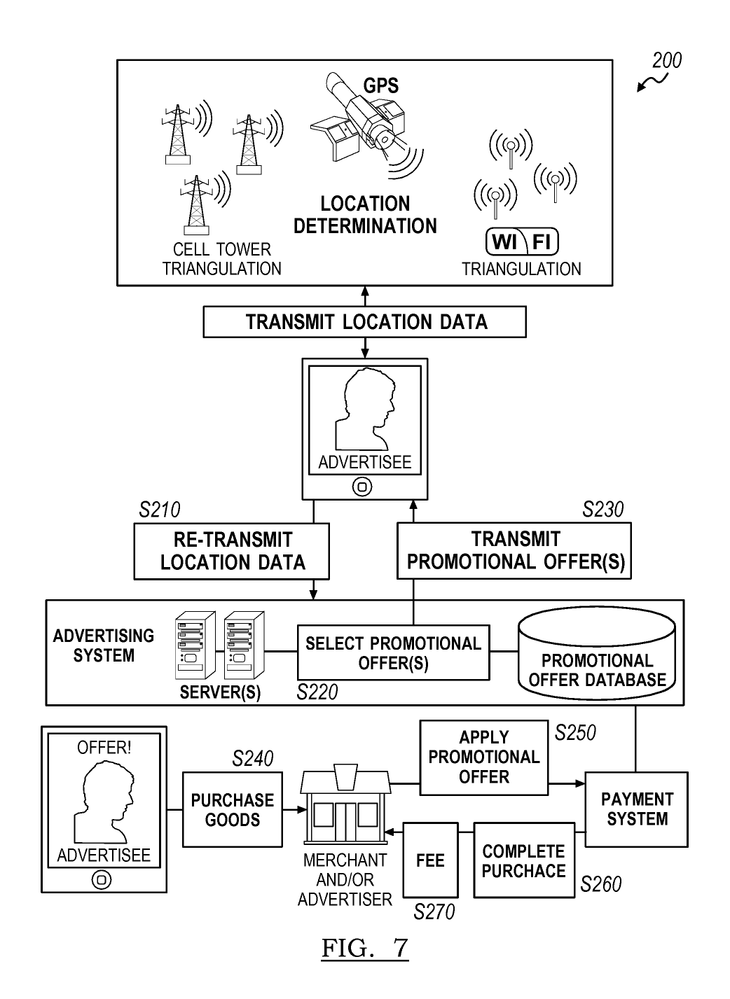

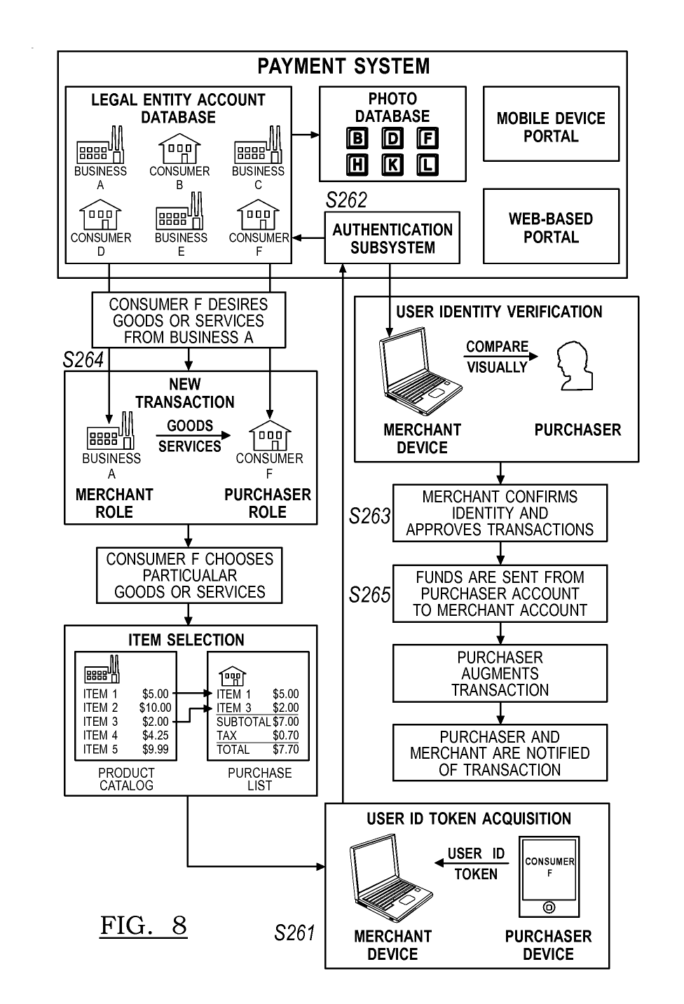

As shown in FIGS. 7 and 8, method 200 of a second preferred embodiment for advertising on a mobile device 200 provides targeted advertising to an advertisee by: selecting a promotional offer S220, sending the selected promotional offer to the mobile device S230, initiating a purchase transaction between the merchant and the advertisee S240, receiving a request of the advertisee to apply the promotional offer to the purchase transaction S250, completing the purchase transaction S260, and charging the advertiser a fee after the purchase transaction is completed S270. The method may additionally include receiving the location information of a mobile device belonging to the advertisee S210.

In the second preferred embodiment, an advertising system is integrated with a payment system, such as the one disclosed in related U.S. patent application Ser. No. 12/641,071. Alternatively, the payment system may use credit cards, debit cards, gift credit, social credit, or any suitable payment method. Steps S210, S220 and S230 are preferably performed by an advertising subsystem of the integrated advertising and payment system, and Steps S240, S250 and S260 are preferably performed by a payment subsystem. Step S270 may be performed by either or both of the advertising and payment subsystem.

The method of the second preferred embodiment is preferably performed by and over an electronic network. The network preferably includes a plurality of merchant terminals, a plurality of purchaser terminals (i.e. mobile devices belonging to advertisees), a user account database, a promotional offer database, a product catalog database, a user review database, one or more payment servers, and one or more advertising servers. The merchant terminal is preferably a checkout device that allows a merchant to interface with the payment servers. Each merchant terminal preferably has an ID token reader, a display, and network capabilities. The purchaser terminal is preferably a mobile device with a display and networking capabilities that allow the advertisee to receive promotional offers from the advertising server. The user account database, the promotional offer database, the product catalog database, and the user review database are preferably internal databases of the network. The databases may be stored on separate computers or may be stored on a single computer. The promotional offer database preferably stores redemption statistics of the promotional offers. Alternatively, redemption statistics may be stored in a redemption statistics database. Preferably, the advertising server selects promotional offers from the promotional offer database and distributes the promotional offers over the network to the purchasing terminals. Preferably, the payment server obtains identity confirmation information from the user accounts database, transmits the identity confirmation to the merchant terminal, and transfers funds between user accounts. Internal databases are preferably shared between the advertising and payment servers. The advertising and payment servers are preferably separate server computers, but may alternatively run on the same server computer, or in server clusters. The advertising subsystem preferably comprises the plurality of purchaser terminals, the one or more advertising servers, the promotional offer database, and the user review database. The payment subsystem preferably comprises the plurality of merchant terminals, the one or more payment servers, the accounts database, and the product catalog database. The payment subsystem may additionally include the plurality of purchaser terminals. The advertising and payment subsystem are preferably fully integrated and share network resources.

In an exemplary application of the method, the advertising subsystem receives the location of a smart phone belonging to an advertisee who is on his way to work. The advertising system searches a database for a promotional offer offered by a merchant whose store is located near the current location of the advertisee. The advertising system then sends the promotional offer to an application running on the smart phone of the advertisee. The advertisee views the promotional offer and stops by the store of the merchant. During checkout, the merchant initiates a purchase transaction and rings up the items of the advertisee (now the purchaser). At this point, either the purchaser requests the promotional offer by showing the merchant the promotional offer displayed on the smart phone and the merchant enters the request into the merchant terminal, or the purchaser is assumed to have entered the transaction based on the promotional offer and the promotional offer is automatically requested. The merchant terminal sends the request to the payment subsystem, which then determines whether the promotional offer is eligible to be applied to the purchase transaction, and applying the promotional offer to the purchase transaction if eligible. To complete the purchase, the merchant terminal receives identity information from the purchaser, such as a user ID token. The payment subsystem then sends identity confirmation information associated with the user ID token to the merchant terminal. After verifying that the identity of the purchaser matches the identity confirmation information, the merchant notifies the merchant terminal of payment approval. Upon receiving the payment approval notification, the payment subsystem transfers funds from the account of the purchaser to the account of the merchant. Once the purchase is complete, the system charges the merchant a promotional offers fee (i.e. an advertising fee) for the redeemed promotional offer.

The second preferred method 200 may additionally include one or more of the following optional steps: saving a promotional offer flagged by the advertisee as an offer of interest S291, performing a promotional offer share request from the advertisee S292, sorting a list of selected promotional offers S293, receiving a user review submission from the advertisee S294, providing a search interface to the promotional offer database S295, and calculating a velocity of the mobile device S296. Steps S291, S292, S293, S294, S295 and S296 of the second preferred embodiment are preferably substantially similar to Steps S191, S192, S193, S194, S195 and S196 of the first preferred embodiment respectively.

Optional Step S210, which includes receiving information about the location of a mobile device belonging to an advertisee, functions to determine the location of the advertisee. Step S210 of the second preferred embodiment is preferably substantially similar to Step S110 of the first preferred embodiment. Preferably, the mobile device is also a purchaser terminal.

Step S220, which includes selecting promotional offers to send to the mobile device of the advertisee, functions to provide a targeted advertising experience to the advertisee. Step S220 of the second preferred embodiment is preferably substantially similar to Step S120 of the first preferred embodiment.

Step S230, which includes sending the selected promotional offers to the mobile device, functions to present the promotional offers to the advertisee. Step S230 of the second preferred embodiment is preferably substantially similar to Step S130 of the first preferred embodiment.

Step S240 includes initiating a purchase transaction between a merchant and the advertisee. The merchant is preferably the same entity as the advertiser of the promotional offer. A purchase transaction is preferably initiated by ringing up a first item for purchase.

Step S250, which includes receiving a request of the advertisee to apply the promotional offer to the purchase transaction, functions to inform the merchant that the advertisee wishes to redeem a promotional offer sent from the integrated advertising and payment system. The advertisee is preferably the same person or entity as the purchaser. The request may be a communication between the advertisee and the merchant. For example, the advertisee may show the promotional offer displayed on the mobile device to the merchant. To assist the advertisee, the mobile device may search for flagged promotional offers redeemable at the mobile device's current location (i.e. the store of the advertiser), and automatically display those promotional offers. Alternatively, the request may be sent automatically by the mobile device. Preferably, the mobile device determines whether any flagged promotional offers are eligible to apply to the purchase transaction, and sends a request to apply the eligible promotional offers. The request is preferably sent to the merchant terminal, but may alternatively be sent to the payment server of the integrated advertising and payment system. Step S250 preferably further includes determining whether the promotional offer is eligible to be applied to the purchase transaction, and applying the promotional offer to the purchase transaction if eligible.

Step S260, which includes completing the purchase transaction, functions to authenticate the identity of the purchaser and transfer payment from the purchaser to the merchant. The purchaser is preferably the same person or entity as the advertisee and the merchant is preferably the advertiser. As shown in FIG. 8, Step S260 preferably authenticates the identity of the purchaser by obtaining a user identification (ID) token of a purchaser Step S261, communicating identity confirmation information associated with the user ID token to the merchant terminal S262, and receiving a payment approval confirmation S263. Step S260 preferably transfers payment from the purchaser to the merchant by assigning the role of a merchant account to a first account and assigning the role of a purchaser account to a second account S264, and transferring funds from the purchaser account to the merchant account S265.

Step S261, which includes obtaining user identification (ID) tokens of a purchaser from a merchant terminal, functions to gather at least one unique identifier of the purchaser. The user ID may be implemented in various forms. Preferably, the user ID is a barcode that encodes a user identification value (e.g., a alphanumeric code). More preferably, the barcode is a Code 128-C barcode corresponding to a user ID stored in an internet-accessible database table uniquely representing an entity account (i.e., the specific individual) used in making the purchase. The barcode is preferably collected from a merchant terminal through a barcode scanner, a camera, or any suitable imaging device. The barcode may be read from a printed card, but may alternatively be displayed on a screen of a mobile device utilizing LCD, LED, OLED, e-Ink, or any suitable display technology. Alternatively, the user ID may be entered manually, read from a magnetic strip, read from an RFID tag or microchip, biometrically scanned, obtained from visual recognition, or entered in any other manner suitable for reading an encoded ID. The user identification value may additionally be used for situations where a barcode cannot be used. The user identification value is preferably an 11-digit value, but any suitable length of code may be used such as any standard code length used in a particular technology (Code 128-C barcode). The user ID is preferably sent over an internet connection to the payment subsystem.

Step S262, which includes communicating identity confirmation information associated with the user ID from the payment subsystem to the merchant terminal, functions to provide the merchant with a way to verify the identity of the purchaser. Preferably, Step S262 includes sending an image associated with the user ID. The image is preferably a photograph of the owner of the purchaser account, which a merchant can use as reference to verify that the purchaser (the person who is attempting to make the purchase and who is likely within visual range of the representative of the merchant) visually matches the person in the photograph associated with the account. Alternatively or in addition, any suitable form of verification may be used such as a security question and answer, a PIN number or password, address information, biometric signatures compared to biometric readings, and/or any other suitable information for identity confirmation.

Step 263, which includes receiving a purchase approval confirmation, functions to ensure that the purchaser has passed the identity verification process. The payment subsystem preferably receives a communication indicating purchase approval or purchase denial from the merchant terminal. The purchase is preferably denied by the representative of the merchant if the information supplied by the purchaser (e.g. the appearance of the purchaser) does not match the identity confirmation information.

Step 264, which includes assigning a role of a merchant account to a first account and a role of a purchaser account to a second account, functions to register a purchaser and a merchant for a purchase transaction. The accounts of the payment subsystem are preferably designed so that an account may selectively function as either a merchant account or a purchaser account during any particular transaction. In other words, within the scope of all transactions, accounts of the payment system can function as bi-directional transaction accounts.

Step 265, which includes transferring funds for the purchase price total to an account of the merchant, functions to complete the purchase transaction. Step S265 is preferably performed after receiving a purchase approval confirmation from the merchant terminal. The purchase price total preferably reflects the price after the promotional offer has been applied. The payment system preferably performs the necessary tasks for transferring funds such as verifying that enough funds are in an account prior to making the transaction to avoid any penalty fees. Additionally, after completing a purchase, the method may additionally store itemized purchase information as a transaction record for the merchant account and/or the purchaser account, which functions to form an itemized purchase history. A purchaser or merchant can preferably access transaction records stored on within their respective accounts. The itemized transaction records can be used for detailed analysis of purchase trends, account budgeting, or any suitable application.

Step S270, which includes charging the advertiser a promotional offer fee after receiving a redemption notification, functions to generate revenue for the advertising system. Step S270 of the second preferred embodiment is preferably substantially similar to Step S150 of the first preferred embodiment.

As a person skilled in the art will recognize from the previous detailed description and from the figures and claims, modifications and changes can be made to the preferred embodiments of the invention without departing from the scope of this invention defined in the following claims.

I claim:

1. A method of providing targeted promotional offers from an advertiser to an advertisee, performed by an electronic advertising system, the method comprising the steps of:
receiving location information of a mobile device belonging to the advertisee;
searching through a promotional offer database;
selecting a promotional offer using the location information of the mobile device as a selection criterion;
sending the promotional offer to the mobile device;
receiving a redemption notification indicating that an advertisee has applied the promotional offer to a completed purchase transaction; and
charging the advertiser a promotional offer fee after receiving the redemption notification.

2. The method of claim 1, wherein the location information is global positioning system (GPS) information.

3. The method of claim 1, wherein the promotional offer database is an internal database of the electronic advertising system.

4. The method of claim 1, wherein sending the promotional offer includes sending the promotional offer to a software application running on the mobile device.

5. The method of claim 1, wherein selecting a promotional offer includes using personal information of the advertisee as a selection criterion, and personal information is selected from a group consisting of: promotional offer redemption history, purchase history, interests, preferences, and demographic information.

6. The method of claim 1, wherein selecting a promotional offer includes using population level information as a selection criterion, and population level information is selected from a group consisting of: user reviews of the advertiser, user reviews of the promotional offer, redemption statistics of the promotional offer, and redemption statistics of similar promotional offers.

7. The method of claim 1, wherein receiving a redemption notification includes one of: receiving the redemption notification from the mobile device and receiving the notification from the advertiser.

8. The method of claim 1, wherein the advertisee applies the promotional offer by showing the promotional offer, displayed on the mobile device, to the advertiser.

9. The method of claim 1, wherein the advertisee applies the promotional offer by paying for goods or services to automatically apply the promotional offer.

10. The method of claim 1, wherein charging the advertiser a promotional offer fee includes one of: charging a fee for an individual redemption notification, and charging a fee calculated based on a total number of redemption notifications received during a specified time interval.

11. The method of claim 1, further comprising:
initiating a purchase transaction;
assigning the role of a merchant account to a first account belonging to the merchant, and assigning the role of a purchaser account to a second account belonging to the advertisee; and
transferring payment for the purchase transaction from the purchaser account to the merchant account, using a payment server.

12. The method of claim 11, wherein receiving a redemption notification includes receiving the redemption notification from a payment server.

13. The method of claim 1, further comprising:
allowing the advertisee to flag the promotional offer as an offer of interest; and
saving the promotional offer on the mobile device when the promotional offer is flagged.

14. The method of claim 2, further comprising:
determining if the flagged promotional offer is eligible to be applied to the purchase transaction; and
automatically applying the flagged promotional offer to the purchase transaction if eligible.

15. The method of claim 2, further comprising deleting the flagged promotional offer from the mobile device upon the expiration of a specified time limit.

16. The method of claim 1, further comprising:
receiving a request from the advertisee to share the promotional offer with a second advertisee, and
sending the promotional offer to a mobile device belonging to a second advertisee.

17. The method of claim 1, wherein selecting a promotional offer includes selecting a plurality of promotional offers, and further comprising the step of sorting the plurality of selected promotional offers based on sorting criteria.

18. The method of claim 1, further comprising:
receiving a user review submission from the advertisee; and
adding the user review submission to a user review database.

19. The method of claim 1, further comprising providing a search interface that allows the advertisee to search through the promotional offer database.

20. A method performed by an electronic advertising and payment network, the network comprising a plurality of merchant terminals connected to at least one advertising server, at least one payment server, an account database, and a promotional offer database, the method comprising:
receiving location information of a mobile device belonging to an advertisee;
selecting a promotional offer from the promotional offer database using the location information of the mobile device as a selection criterion;
sending the promotional offer from the advertising server to the mobile device;
initiating a purchase transaction;
assigning the role of a merchant account to a first account belonging to the merchant, and assigning the role of a purchaser account to a second account belonging to the advertisee;
receiving, with a merchant terminal, a request of the advertisee to apply the promotional offer to the purchase transaction;
applying the promotional offer to the purchase transaction;
completing the purchase transaction by transferring, with the payment server, payment for the purchase transaction from the purchaser account to the merchant account; and
charging the merchant account a promotional offer fee after the completion of the purchase transaction.

21. A method performed over a payment network, the payment network comprising a plurality of merchant terminals connected to a plurality of payment servers, an accounts database, and a promotional offer database wherein each merchant terminal has an ID token reader, a display, and network capabilities, the method comprising the steps of:
selecting a promotional offer made available by a merchant from the promotional offer database;
sending the promotional offer to a mobile device of a purchaser;
initiating a purchase transaction;
receiving a request of the purchaser to apply the promotional offer to the purchase transaction;
applying the promotional offer to the purchase transaction;
reading, with the ID token reader of a merchant terminal, the user ID token of the purchaser and sending the user ID token to a payment server;
transmitting, from the payment server to the merchant terminal, identity confirmation information associated with the user ID token;
transmitting, from the merchant terminal to the payment server, a payment approval communication;
assigning the role of a merchant account to a first account belonging to the merchant and the role of a purchaser account to a second account belonging to the purchaser;
transferring, with the payment server, payment for the purchase transaction from the purchaser account to the merchant account; and
charging the merchant account a promotional offer fee after the payment transfer.

22. The method of claim 21, further comprising receiving location information of a purchaser terminal, and wherein selecting a promotional offer further includes using the location information of the purchaser terminal as a selection criterion.

23. The method of claim 21, wherein selecting a promotional offer further includes using purchaser information from the purchaser account as a selection criterion.

24. The method of claim 23, wherein the purchaser information is the itemized purchase history of the purchaser.
